(19) United States
(12) Patent Application Publication
(10) Pub. No.: US 2026/0259607 A1
(43) Pub. Date: Sep. 3, 2026

(54) SYSTEM

(71) Applicant: SOFTBANK GROUP CORP., Tokyo (JP)

(72) Inventor: Yoko SEGAMI, Tokyo (JP)

(73) Assignee: SOFTBANK GROUP CORP., Tokyo (JP)

(21) Appl. No.: 19/554,726

(22) Filed: Mar. 3, 2026

Related U.S. Application Data
(60) Provisional application No. 63/766,210, filed on Mar. 3, 2025.

(51) Int. Cl. G06F 3/01; G06N 3/049

(52) U.S. Cl. CPC G06F 3/015; G06N 3/049

(57) ABSTRACT

A system for operating electronic devices by converting brainwave signals into digital signals and analyzing the user's intent using generative AI is disclosed. A sensor unit is attached to the user's head to capture brain electrical activity with high precision. The conversion unit converts analog signals to digital signals, and the generative AI unit uses deep learning to estimate the user's intent. The estimated intent is converted into an operation command by the control unit and executed on a terminal such as a smartphone. This enables the provision of an intuitive and efficient interface for users with physical limitations or those requiring operation in complex environments. A server-side database accumulates brainwave data and operation history to support AI learning.

### CROSS-REFERENCE TO RELATED APPLICATION

This application claims priority under 35 U.S.C. § 119 to U.S. Provisional Patent Application No. 63/766,210, filed on March 3, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

### SUMMARY

The difficulty in operating electronic devices using conventional methods due to physical or environmental constraints is addressed. Specifically, providing a more intuitive and efficient interface for users who find hand or finger-based operation difficult, or who wish to operate devices without relying on vision or hearing is disclosed. Furthermore, in VR, AR, and vehicle interfaces, managing multiple tasks simultaneously without relying on vision or touch is required during multitasking, yet means to achieve this are lacking.

Additionally, operation using brainwave signals has limitations in accuracy and speed with conventional technology, making it difficult to accurately reflect the user's intent. These challenges are addressed by converting brainwave signals into digital signals and analyzing user intent using generative AI. This enables thoughts to be directly linked to electronic device operation. Consequently, it provides a more free and efficient operating experience for users with physical limitations or those requiring operation in complex environments.

As a means to solve these issues, a system comprising: a sensor unit for acquiring brainwave signals; a conversion unit for converting analog signals into digital signals; a generative AI unit for analyzing the digital signals and estimating the user's intent; and a control unit for operating electronic devices based on the estimated intent is provided. The sensor unit is worn on the user's head and captures brainwaves across multiple frequency bands—such as alpha, beta, gamma, delta, and theta waves—with high precision. The conversion unit converts the analog signals from the sensor unit into digital signals, thereby making them processable by computers or AI systems. The generative AI unit learns patterns in the brainwave signals using deep learning and neural networks. Based on past brainwave data and the user's operation history, it models how specific brainwave patterns correspond to particular operations. The control unit converts the user's intent, estimated by the generative AI unit, into operation commands and sends them to the electronic device. This enables the user's thoughts to be directly linked to the operation of the electronic device. In this way, it provides a more intuitive and efficient interface for users who have difficulty operating devices using conventional methods due to physical limitations or environmental constraints.

### BRIEF DESCRIPTION OF THE DRAWINGS

FIG. 1 is a conceptual diagram showing an example configuration of the data processing system according to the first embodiment.

FIG. 2 is a conceptual diagram showing an example of the main functional components of the data processing device and smart device according to the first embodiment.

FIG. 3 is a conceptual diagram showing an example configuration of a data processing system according to a second embodiment.

FIG. 4 is a conceptual diagram showing an example of the main functions of the data processing device and smart glasses according to the second embodiment.

FIG. 5 is a conceptual diagram showing an example configuration of a data processing system according to a third embodiment.

FIG. 6 is a conceptual diagram showing an example of the main functions of the data processing device and headset-type terminal according to the third embodiment.

FIG. 7 is a conceptual diagram showing an example configuration of a data processing system according to the fourth embodiment.

FIG. 8 is a conceptual diagram showing an example of the main functions of the data processing device and robot according to the fourth embodiment.

FIG. 9 shows an emotion map onto which multiple emotions are mapped.

FIG. 10 shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, a processor (hereinafter simply referred to as a "processor") may be a single arithmetic unit or a combination of multiple arithmetic units. Furthermore, the processor may be a single type of arithmetic unit or a combination of multiple types of arithmetic units. Examples of processing units include a CPU (Central Processing Unit), a GPU (Graphics Processing Unit), a GPGPU (General-Purpose Computing on Graphics Processing Units), an APU (Accelerated Processing Unit), and the like.

In the following embodiments, signed RAM (Random Access Memory) is a memory where information is temporarily stored and is used as working memory by the processor.

In the following embodiments, the signed storage is one or more non-volatile storage devices that store various programs and various parameters, etc. Examples of non-volatile storage devices include flash memory (SSD (Solid State Drive)), magnetic disks (e.g., hard disk), or magnetic tape.

In the following embodiments, the communication I/F (Interface) is an interface that includes a communication processor and an antenna, among other components. The communication I/F governs communication between multiple computers. Examples of communication standards applicable to the communication I/F include wireless communication standards such as 5G (5th Generation Mobile Communication System), Wi-Fi (registered trademark), or Bluetooth (registered trademark).

In the following embodiments, "A and/or B" is synonymous with "at least one of A and B." That is, "A and/or B" may mean only A, only B, or a combination of A and B. Furthermore, in this specification, when three or more items are connected using "and/or," the same concept applies as for "A and/or B".

### First Embodiment

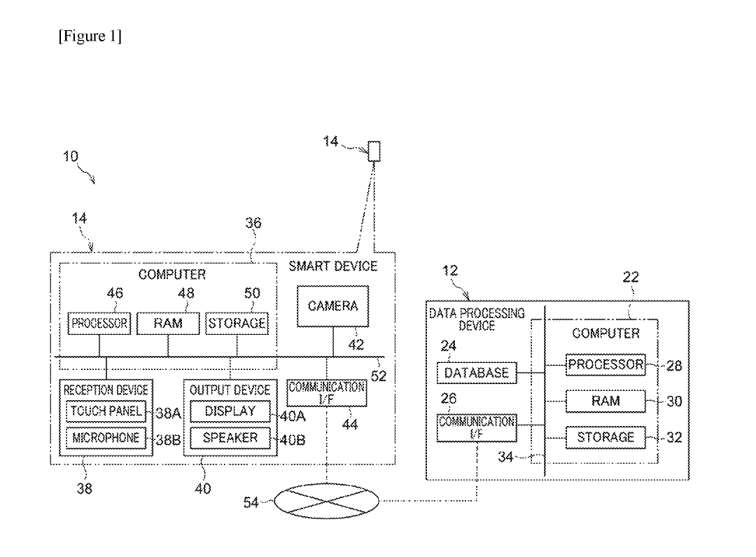

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52. The reception device 38, output device 40, and camera 42 are also connected to the bus 52.

The reception device 38 includes a touch panel 38A and a microphone 38B, among other components, and receives user input. The touch panel 38A receives user input via contact with an indicator (e.g., a pen or finger) by detecting such contact. The microphone 38B receives voice-based user input by detecting the user's voice. The control unit 46A transmits data indicating the user input received via the touch panel 38A and microphone 38B to the data processing unit 12. Within the data processing unit 12, the specific processing unit 290 acquires the data indicating the user input.

Output device 40 includes display 40A and speaker 40B, among others, and presents data to user 20 by outputting it in a form perceptible to user 20 (e.g., audio and/or text). Display 40A displays visual information such as text and images according to instructions from processor 46. Speaker 40B outputs audio according to instructions from processor 46. Camera 42 is a compact digital camera equipped with an optical system including a lens, aperture, and shutter, and an imaging element such as a CMOS (Complementary Metal-Oxide-Semiconductor) image sensor or a CCD (Charge Coupled Device) image sensor.

The communication interface 44 is connected to the network 54. The communication interfaces 44 and 26 manage the exchange of various information between processor 46 and processor 28 via network 54.

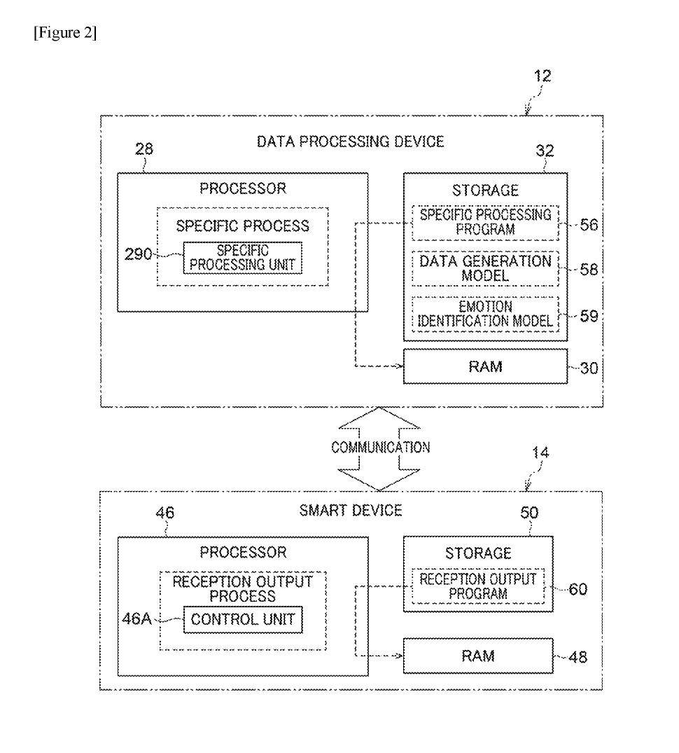

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart device 14 performs reception output processing via the processor 46. The reception output program 60 is stored in the storage 50. The reception output program 60 is used in conjunction with the specific processing program 56 by the data processing system 10. The processor 46 reads the reception output program 60 from the storage 50 and executes the read reception output program 60 on the RAM 48. The specific processing is performed by the processor 46 operating as a control unit 46A according to the specific processing program 60 executed on the RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on the RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may be the server device itself, or it may be a terminal device owned by a user (e.g., a mobile phone, robot, home appliance, etc.). Next, an example of processing by the data processing system 10 according to the first embodiment will be described.

### Example 1

The flow of the specific processing in Example 1 is described below. The components of the system described below are implemented by the data processing device 12 and the smart device 14. The data processing device 12 is referred to as the "server," and the smart device 14 is referred to as the "terminal."

### Implementation Examples for Carrying Out the Invention

The embodiment for implementing the present invention will now be described in further detail. This system adopts a configuration realized on both the server and the terminal, enabling the user's thoughts to be directly linked to electronic device operations by each component performing its respective role.

First, the sensor unit for acquiring brainwave signals will be described. This sensor unit is designed as a wearable device worn on the user's head and incorporates multiple electrodes. These electrodes make direct contact with the scalp to capture the brain's electrical activity with high precision. For example, the sensor unit includes a sensor section equipped with multiple electrodes designed as a wearable device worn on the user's head and equipped with multiple electrodes. These electrodes make direct contact with the scalp to capture the brain's electrical activity with high precision. For example, the sensor unit includes filtering functions to reduce noise, minimizing interference from the external environment. Furthermore, the sensor unit is constructed from flexible materials to provide a lightweight and comfortable fit, designed to avoid burdening the user even during prolonged use.

Next, the conversion unit that converts analog signals into digital signals is described. This conversion unit receives analog signals from the sensor unit and converts them into digital signals using an analog-to-digital converter with a high sampling rate. For example, the conversion unit sets the sampling rate to several thousand times per second, enabling it to accurately capture minute changes in brain waves. Furthermore, the conversion unit employs technology to minimize quantization error, thereby improving the precision of the digital signals.

The generative AI unit is primarily implemented on the server side. This AI unit uses deep learning and neural networks to learn patterns in brainwave signals. Specifically, the AI unit processes large amounts of brainwave data in the cloud to generate customized models for each user. For example, the AI unit can compare and analyze brainwave data from different users to construct intent estimation models optimized for individual users. Furthermore, the AI unit implements algorithms to receive new EEG data as input in real time and to quickly and accurately estimate the user's intent.

The control unit is located on the terminal side and is responsible for converting the user's intent, estimated by the generative AI unit, into operation commands. For example, the control unit can interact with the operating system of a smartphone or tablet to perform operations such as opening applications, sending messages, playing music, or even changing specific settings based on the user's intent. The control unit provides customization options to optimize the user interface and enable intuitive operation.

Furthermore, a database for storing and managing data is placed on the server side. This database accumulates the user's brainwave data and operation history, serving as the foundation for the generative AI unit to reference and learn from this data. For example, the database can manage user-specific profiles and provide operation models optimized for each individual user. Additionally, the database employs encryption technology to enhance security measures and protect user privacy.

In this way, the system of the present invention enables the direct connection of a user's thoughts to the operation of electronic devices through the coordinated operation of the server and terminal. This provides a more intuitive and efficient interface for users who, due to physical or environmental constraints, found operation difficult using conventional methods.

### System Configuration

The system according to this embodiment comprises a sensor unit, a conversion unit, a generative AI unit, a control unit, and a database unit. The sensor unit is designed as a wearable device worn on the user's head and includes multiple electrodes. These electrodes make direct contact with the scalp to capture the brain's electrical activity with high precision. For example, the sensor unit incorporates filtering functions to reduce noise, minimizing interference from the external environment. Furthermore, the sensor unit is constructed from flexible materials to provide a lightweight and comfortable fit, designed to avoid burdening the user even during prolonged use. Additionally, the sensor unit can simultaneously acquire brainwaves across different frequency bands, enabling accurate reflection of the user's diverse mental states. Moreover, the sensor unit incorporates wireless communication functionality, allowing it to transmit acquired brainwave data to a terminal in real time.

The conversion unit receives analog signals from the sensor unit and converts them into digital signals using an analog-to-digital converter with a high sampling rate. For example, the conversion unit can set the sampling rate to several thousand times per second, enabling it to accurately capture minute changes in brainwaves. Furthermore, the conversion unit employs technology to minimize quantization error, thereby improving the precision of the digital signals. Furthermore, the conversion unit can compress the digital signal to improve data transfer efficiency. Additionally, the conversion unit is equipped with a function to detect abnormal brainwave patterns and issue warnings.

The generative AI unit is primarily implemented on the server side. This AI unit uses deep learning and neural networks to learn patterns in brainwave signals. Specifically, the AI unit processes large amounts of brainwave data in the cloud to generate customized models for each user. For example, the AI unit can compare and analyze brainwave data from different users to build intent estimation models optimized for individual users. Furthermore, the AI unit implements algorithms to receive new EEG data in real time as input and to quickly and accurately estimate the user's intent. Additionally, the AI unit can analyze the user's operation history and form a feedback loop to improve operation accuracy. Moreover, the AI unit has the capability to learn abnormal EEG patterns and monitor the user's health status.

The control unit is located on the terminal side and is responsible for converting the user's intent estimated by the generative AI unit into operation commands. For example, the control unit can interact with the operating system of a smartphone or tablet to execute operations such as opening applications, sending messages, playing music, or even changing specific settings based on the user's intent. The control unit provides customization options to optimize the user interface and enable intuitive operation. Furthermore, the control unit is equipped with multitasking capabilities to manage multiple tasks simultaneously. Additionally, the control unit can execute automated operation sequences based on the user's intent.

The database unit is located on the server side and handles data storage and management. This database accumulates user brainwave data and operation histories, serving as the foundation for the generative AI unit to reference and learn from this data. For example, the database manages user-specific profiles and can provide operation models optimized for individual users. Furthermore, the database employs encryption technology to enhance security measures and protect user privacy. Additionally, the database includes data backup functionality to prevent data loss. Moreover, the database can collect user feedback to aid in system improvement.

Specific examples of prompt sentences to be loaded into the generative AI required for implementing the present invention include: "Analyze the user's brainwave data, identify specific patterns, and estimate their intent," "Learn the user's operational tendencies based on past operation history and improve accuracy," and "Detect abnormal brainwave patterns and monitor health status." These prompt sentences serve as guidelines for the AI to accurately estimate the user's intent and execute appropriate operations.

### Implementation Steps

### Step 1: Acquisition of Brainwave Signals

The user acquires brainwave signals using a sensor unit worn on the head. This sensor unit is equipped with multiple electrodes that make direct contact with the scalp to capture brain electrical activity with high precision. It features filtering capabilities to reduce noise, minimizing interference from external environments. The sensor unit is constructed from flexible materials to provide a lightweight and comfortable fit, designed to avoid burdening the user even during prolonged use. It can simultaneously acquire brainwaves across different frequency bands, enabling accurate reflection of the user's diverse mental states.

### Step 2: Analog-to-Digital Conversion

The analog signals acquired from the sensor unit are converted into digital signals by the conversion unit. This conversion unit employs an analog-to-digital converter with a high sampling rate, enabling it to accurately capture subtle changes in brainwaves. The sampling rate is set to several thousand times per second. To enhance the precision of the digital signals, technology is employed to minimize quantization error. The digital signal is compressed to improve data transfer efficiency.

### Step 3: Intent Estimation by Generative AI

The digitized brainwave signals are transmitted to the server-side generative AI unit. The AI unit uses deep learning and neural networks to learn patterns in the brainwave signals and estimates the user's intent. It processes large amounts of brainwave data in the cloud to generate customized models for each user. For example, it can compare and analyze brainwave data from different users to build intent estimation models optimized for each individual. It implements algorithms to receive new brainwave data as input in real time and estimate intent quickly and accurately. Specific examples of prompts fed to the generative AI include: "Analyze the user's brainwave data, identify specific patterns, and estimate intent," "Learn the user's operational tendencies based on past operation history to improve accuracy," and "Detect abnormal brainwave patterns to monitor health status."

### Step 4: Generation and Execution of Operation Commands

The user's intent estimated by the generative AI unit is sent to the terminal-side control unit and converted into an operation command. The control unit interfaces with the smartphone or tablet's operating system to execute operations based on the user's intent, such as opening applications, sending messages, playing music, or even modifying specific settings. It provides customization options to optimize the user interface and enable intuitive operation. Equipped with multitasking capabilities to manage multiple tasks simultaneously, it can execute automated operation sequences based on the user's intent.

### Step 5: Data Storage and Management

The server-side database component accumulates user brainwave data and operation histories, serving as the foundation for the generative AI component to reference and learn from this data. The database manages user-specific profiles, enabling the provision of operation models optimized for each individual user. It employs encryption technology to enhance security measures and protect user privacy. Equipped with data backup functionality, it prevents data loss. It collects user feedback to aid in system improvement.

### Specific Use Cases

For example, consider a user with physical limitations who finds it difficult to operate using hands or fingers, yet wishes to send messages using a smartphone. This user acquires brainwave signals through a sensor unit worn on the head. The sensor unit incorporates multiple electrodes that make direct contact with the scalp to capture the brain's electrical activity with high precision. The acquired analog signals are converted into digital signals by the conversion unit. The conversion unit employs an analog-to-digital converter with a high sampling rate to accurately capture subtle changes in the brainwaves.

Digitized brainwave signals are transmitted to the server-side generative AI unit. The generative AI unit uses deep learning and neural networks to learn patterns in the brainwave signals and estimate the user's intent. It processes large volumes of brainwave data in the cloud to generate customized models for each user. The AI unit receives new brainwave data as input in real time, enabling rapid and accurate intent estimation. Specific examples of prompts fed to the generative AI include: "Analyze the user's brainwave data, identify specific patterns, and estimate intent," "Learn the user's operational tendencies based on past operation history to improve accuracy," and "Detect abnormal brainwave patterns and monitor health status."

The estimated user intent is sent to the terminal-side control unit and converted into an operation command. The control unit interfaces with the smartphone's operating system to execute operations such as opening a messaging application, entering a message, selecting a recipient, and sending the message, all based on the user's intent. It provides customization options to optimize the user interface and enable intuitive operation. It features multitasking capabilities to manage multiple tasks simultaneously and can execute automated operation sequences based on the user's intent.

In this way, it provides a more intuitive and efficient interface for users who find conventional methods difficult to operate due to physical limitations. The system of the present invention enables the direct connection of the user's thoughts to the operation of electronic devices, significantly enhancing user convenience.

### Application Example 1

The flow of specific processing in Application Example 1 is described below. The components of the system described below are implemented by the data processing device 12 and the smart device 14. The data processing device 12 is referred to as the "server," and the smart device 14 is referred to as the "terminal."

### Implementation Examples for the Present Invention

The embodiment for implementing the present invention is described in further detail below. This system is designed for the nursing care field to operate a nursing care robot using brainwave signals. The system comprises a sensor unit, a conversion unit, a generative AI unit, and a control unit. These units operate cooperatively to reflect the user's intent in the operation of the nursing care robot.

First, the sensor unit is described. The sensor unit is a wearable device worn on the user's head, equipped with multiple electrodes. These electrodes make direct contact with the scalp to capture the brain's electrical activity with high precision. For example, the sensor unit includes filtering functions to reduce noise, minimizing interference from the external environment. Specifically, the sensor unit incorporates a shielding function to block surrounding electromagnetic waves and mechanical vibrations, preserving signal purity. Furthermore, the sensor unit is constructed from flexible materials to provide a lightweight and comfortable fit, designed to avoid burdening the user even during prolonged use. Additionally, the sensor unit can simultaneously acquire brainwaves across different frequency bands, accurately reflecting the user's diverse mental states. For example, it can simultaneously capture alpha waves, beta waves, gamma waves, delta waves, theta waves, etc. By analyzing each waveform, it can determine the user's state of relaxation or concentration. Additionally, the sensor unit incorporates wireless communication functionality, enabling real-time transmission of acquired brainwave data to a terminal. This allows for unrestricted movement and free action by the user.

Next, the conversion unit is described. The conversion unit receives analog signals from the sensor unit and converts them into digital signals using an analog-to-digital converter with a high sampling rate. For example, the conversion unit can set the sampling rate to several thousand times per second, enabling it to accurately capture minute changes in brainwaves. This ensures that even instantaneous fluctuations in brainwaves are not missed, allowing for precise detection of the user's intent. Furthermore, the conversion unit employs techniques to minimize quantization error, thereby enhancing the precision of the digital signal. Specifically, it increases the number of quantization bits for the signal, achieving finer signal resolution and generating a highly accurate digital signal. Furthermore, the conversion unit can compress digital signals to improve data transfer efficiency. For example, using compression algorithms that reduce signal redundancy saves communication bandwidth and enables real-time data processing. Additionally, the conversion unit is equipped with a function to detect abnormal brainwave patterns and issue warnings. This allows for constant monitoring of the user's health status and enables rapid response if abnormalities are detected.

The generative AI unit is primarily implemented on the server side. This AI unit uses deep learning and neural networks to learn patterns in brainwave signals and estimate the user's intent. Specifically, the AI unit processes large amounts of brainwave data in the cloud to generate customized models for each user. For example, the AI unit can compare and analyze EEG data from different users to build intent estimation models optimized for each individual. This enables highly accurate intent estimation tailored to each user's specific needs. Furthermore, the AI unit receives new EEG data as input in real time and implements algorithms to quickly and accurately estimate the user's intent. For instance, by using predictive models based on past data, it can anticipate the user's intent in advance, enabling smooth operation. Furthermore, the AI unit can analyze user operation history to form a feedback loop that improves operational accuracy. This enables the system to learn with each use, allowing for increasingly precise operations. Additionally, the AI unit is equipped with the capability to learn abnormal brainwave patterns and monitor the user's health status. This supports user health management and facilitates coordination with medical institutions when necessary.

The control unit is responsible for controlling the care robot's actions. The estimated user intent is sent to the control unit and converted into operation commands. For example, the control unit controls the robot's actions and executes operations based on the user's intent, such as meal preparation, medication management, mobility assistance, and emergency alerts. Specifically, if the user thinks "I want to drink water," the control unit sends a "provide water" command to the robot. The robot then retrieves water from the designated location and provides it to the user. If the user thinks "I want to move," the robot operates the wheelchair based on the user's intent, supporting safe movement. Furthermore, if the user thinks "It's time to take medicine," the robot manages the medication and provides it at the appropriate time. The control unit provides customization options to optimize the user interface and enable intuitive operation. This allows users to select operating methods according to their preferences. Furthermore, the control unit features multitasking capabilities to manage multiple tasks simultaneously. This enables users to issue multiple instructions at once, facilitating efficient operation. Additionally, the control unit can execute automated operation sequences based on the user's intent. This automates routine daily tasks and reduces the user's burden. Based on the user's intent, the control unit can execute automated operation sequences. This automates routine daily tasks, reducing the user's burden.

In this way, the system of the present invention enables the user's thoughts to be directly connected to the operation of the care robot through the coordinated operation of each part. This provides a more intuitive and efficient interface for users who found operation difficult using conventional methods due to physical or environmental constraints.

### System Configuration

The system according to this embodiment comprises a sensor unit, a conversion unit, a generative AI unit, and a control unit. The sensor unit is a wearable device worn on the user's head, equipped with multiple electrodes. These electrodes make direct contact with the scalp to capture brain electrical activity with high precision. The sensor unit includes filtering functions to reduce noise, minimizing interference from the external environment. Specifically, it incorporates a shielding function to block surrounding electromagnetic waves and mechanical vibrations, preserving signal purity. Furthermore, the sensor unit is constructed from flexible materials to provide a lightweight and comfortable fit, designed to avoid burdening the user even during prolonged use. Additionally, the sensor unit can simultaneously acquire brainwaves across different frequency bands, enabling accurate reflection of the user's diverse mental states. For example, it can simultaneously capture alpha waves, beta waves, gamma waves, delta waves, and theta waves. By analyzing each waveform, it can determine the user's state of relaxation or concentration. Additionally, the sensor unit incorporates wireless communication functionality, enabling it to transmit acquired brainwave data to a terminal in real time. This allows the user to move freely without restriction.

The conversion unit receives analog signals from the sensor unit and converts them into digital signals using an analog-to-digital converter with a high sampling rate. The conversion unit sets the sampling rate to several thousand times per second, enabling it to accurately capture minute changes in brainwaves. This ensures that even instantaneous fluctuations in brainwaves are not missed, allowing for precise detection of the user's intent. Furthermore, the conversion unit employs techniques to minimize quantization error, thereby enhancing the precision of the digital signal. Specifically, it increases the number of quantization bits for the signal, achieving finer signal resolution and generating a highly accurate digital signal. Furthermore, the conversion unit can compress digital signals to improve data transfer efficiency. For example, using compression algorithms that reduce signal redundancy saves communication bandwidth and enables real-time data processing. Additionally, the conversion unit is equipped with a function to detect abnormal brainwave patterns and issue warnings. This allows for constant monitoring of the user's health status and enables rapid response if abnormalities are detected.

The generative AI component is primarily implemented on the server side. This AI component uses deep learning and neural networks to learn patterns in brainwave signals and estimate user intent. Specifically, the AI component processes large amounts of brainwave data in the cloud to generate customized models for each user. For example, the AI unit can compare and analyze brainwave data from different users to build intent estimation models optimized for each individual. This enables highly accurate intent estimation tailored to each user's specific needs. Furthermore, the AI unit receives new brainwave data as input in real time and implements algorithms to quickly and accurately estimate user intent. For instance, by utilizing predictive models based on historical data, it can anticipate user intent in advance, enabling smoother operation. Furthermore, the AI unit can analyze user operation history to form a feedback loop that improves operational accuracy. This allows the system to learn with each use, enabling increasingly precise operations. Additionally, the AI unit learns abnormal EEG patterns and possesses functionality to monitor the user's health status. This supports user health management and facilitates coordination with medical institutions when necessary. AI unit also learns abnormal brainwave patterns and monitors the user's health status. This supports the user's health management and enables coordination with medical institutions when necessary. Specific examples of prompt sentences to feed into the generative AI include: "Analyze the user's brainwave data, identify specific patterns, and infer intent," "Learn the user's operational tendencies based on past operation history and improve accuracy," and "Detect abnormal brainwave patterns and monitor health status."

The control unit is responsible for controlling the care robot's actions. The estimated user intent is sent to the control unit and converted into operation commands. The control unit manages the robot's actions, executing operations such as meal preparation, medication management, mobility assistance, and emergency alerts based on the user's intent. Specifically, if the user thinks "I want to drink water," the control unit sends the command "Provide water" to the robot. The robot then retrieves water from the designated location and offers it to the user. Similarly, if the user intends to "move," the robot operates the wheelchair based on this intent, providing safe mobility support. Furthermore, if the user intends to "take medication," the robot manages the medication and provides it at the appropriate time. The control unit offers customization options to optimize the user interface and enable intuitive operation. This allows users to select operating methods according to their preferences. Furthermore, the control unit features multitasking capabilities to manage multiple tasks simultaneously. This allows users to issue multiple instructions at once, enabling efficient operation. Additionally, the control unit can execute automated operation sequences based on the user's intent. This automates routine daily tasks, reducing the user's burden.

Thus, the system according to this embodiment enables the user's thoughts to be directly translated into operations of the care robot through the coordinated operation of its various components. This provides a more intuitive and efficient interface for users who previously found operation difficult due to physical or environmental constraints.

### Implementation Steps

### Step 1: Acquisition of Brainwave Signals

The user acquires brainwave signals using a sensor unit worn on the head. This sensor unit is equipped with multiple electrodes that make direct contact with the scalp to capture the brain's electrical activity with high precision. The sensor unit incorporates filtering functions to reduce noise, minimizing interference from the external environment. Specifically, it features shielding capabilities to block surrounding electromagnetic waves and mechanical vibrations, preserving signal purity. Furthermore, the sensor unit is constructed from flexible materials to provide a lightweight and comfortable fit, designed to avoid burdening the user even during prolonged use. Additionally, the sensor unit can simultaneously acquire brainwaves across different frequency bands, enabling accurate reflection of the user's diverse mental states.

### Step 2: Analog-to-Digital Conversion

The analog signals acquired from the sensor unit are converted into digital signals by the conversion unit. The conversion unit employs an analog-to-digital converter with a high sampling rate, enabling it to accurately capture subtle changes in brainwaves. The sampling rate is set to several thousand times per second, and techniques are employed to minimize quantization error, thereby improving the precision of the digital signal. The digital signals are compressed to improve data transfer efficiency. Furthermore, the conversion unit is equipped with a function to detect abnormal brainwave patterns and issue warnings.

### Step 3: Intent Estimation by Generative AI

The digitized brainwave signals are transmitted to the server-side generative AI unit. The generative AI unit uses deep learning and neural networks to learn patterns in the brainwave signals and estimate the user's intent. It processes large volumes of brainwave data in the cloud to generate customized models for each user. The AI unit receives new brainwave data as input in real time, enabling rapid and accurate intent estimation. Specific examples of prompts fed to the generative AI include: "Analyze the user's brainwave data, identify specific patterns, and estimate intent," "Learn the user's operational tendencies based on past operation history to improve accuracy," and "Detect abnormal brainwave patterns and monitor health status."

### Step 4: Generation and Execution of Operation Commands

The user's intent estimated by the generative AI unit is sent to the control unit and converted into an operation command. The control unit manages the care robot's actions, executing operations such as meal preparation, medication management, mobility assistance, and emergency alerts based on the user's intent. The control unit provides customization options to optimize the user interface and enable intuitive operation. It features multitasking capabilities to manage multiple tasks simultaneously and can execute automated operation sequences based on the user's intent.

### Step 5: Data Storage and Management

The server-side database unit accumulates user brainwave data and operation histories, forming the foundation for the generative AI unit to reference and learn from this data. The database manages individual user profiles and can provide operation models optimized for each user. It employs encryption technology to enhance security measures and protect user privacy. It includes data backup functionality to prevent data loss. It can collect user feedback to aid in system improvement.

### Specific Use Cases

For example, consider an elderly person with physical limitations who finds independent mobility difficult and uses a care robot in daily life. This person acquires brainwave signals using a sensor unit worn on the head. The sensor unit is equipped with multiple electrodes that make direct contact with the scalp to capture brain electrical activity with high precision. It incorporates filtering functions to reduce noise, minimizing interference from the external environment. The acquired analog signals are converted into digital signals by the conversion unit. The conversion unit uses an analog-to-digital converter with a high sampling rate to accurately capture subtle changes in the brainwaves.

The digitized brainwave signals are transmitted to the generative AI unit on the server side. The generative AI unit uses deep learning and neural networks to learn patterns in the brainwave signals and estimate the elderly person's intent. It processes large amounts of brainwave data in the cloud to generate customized models for each elderly individual. The AI unit receives new brainwave data as input in real time, enabling rapid and accurate intent estimation. Specific examples of prompts fed to the generative AI include: "Analyze the elderly person's brainwave data, identify specific patterns, and estimate intent," "Learn the elderly person's operational tendencies based on past operation history to improve accuracy," and "Detect abnormal brainwave patterns and monitor health status."

The estimated intent of the elderly person is transmitted to the control unit of the care robot and converted into an operation command. The control unit manages the robot's actions and executes operations based on the elderly person's intent, such as preparing meals, managing medication management, mobility assistance, and emergency notifications. For example, if an elderly person thinks "I want to drink water," the control unit sends a "provide water" command to the robot. The robot then retrieves water from the designated location and offers it to the elderly person. Similarly, if an elderly person thinks "I want to move," the robot operates the wheelchair based on their intent, providing safe mobility support. Furthermore, when the elderly person thinks "it's time to take medication," the robot manages the medication and provides it at the appropriate time.

In this way, it is possible to provide a more intuitive and efficient interface for elderly individuals who find conventional methods difficult to operate due to physical limitations. The system of the present invention enables the direct connection of an elderly person's thoughts to the operation of a care robot, thereby improving the quality of life for the elderly.

The specific processing unit 290 transmits the result of the specific processing to the smart device 14. On the smart device 14, the control unit 46A causes the output device 40 to output the result of the specific processing. The microphone 38B acquires audio indicating user input regarding the result of the specific processing. The control unit 46A transmits the audio data indicating the user input acquired by the microphone 38B to the data processing unit 12. At the data processing unit 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats such as audio data, text data, and image data. The data generation model 58 includes, for example, text generation AI, image generation AI, multimodal generation AI, etc. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Moreover, the specific processing unit 290 of the data processing device 12 obtains or collects information necessary for processing from the smart device 14 or an external device, and the smart device 14 may acquire or collect information necessary for processing from the data processing device 12 or an external device.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart device 14.

### Second Embodiment

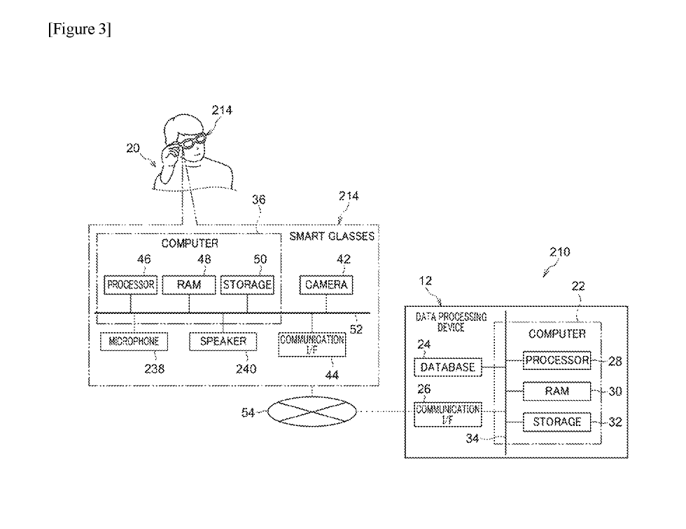

FIG. 3 shows an example configuration of the data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 is an example of a "computer" related to the technology of this disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart glasses 214 include a computer 36, a microphone 238, a speaker 240, a camera 42, and a communication I/F 44. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

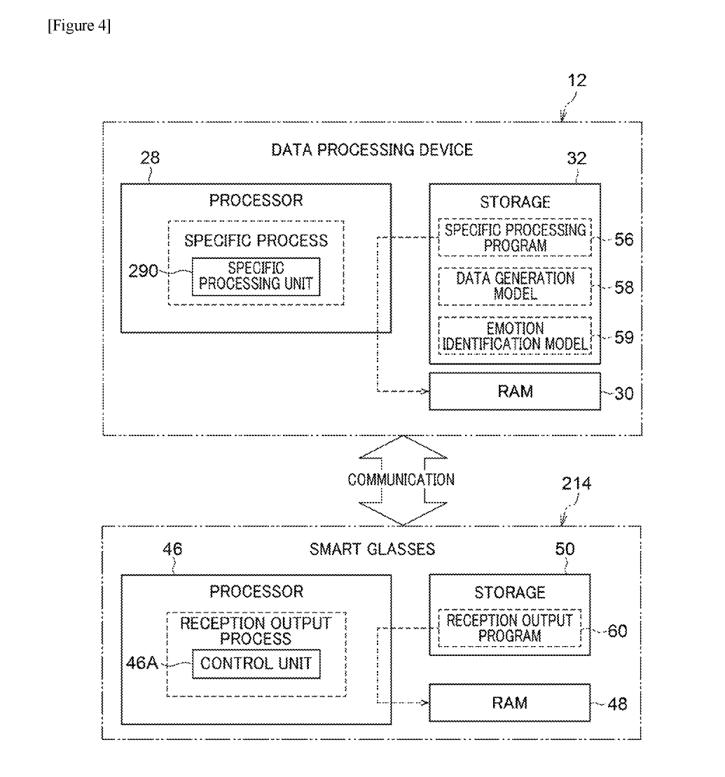

FIG. 4 shows an example of the main functions of the data processing device 12 and the smart glasses 214. As shown in FIG. 4, specific processing is performed by the processor 28 in the data processing device 12. The specific processing program 56 is stored in the storage 32.

The specific processing program 56 is an example of a "program" related to the technology of the present disclosure. Processor 28 reads the specific processing program 56 from storage 32 and executes the read specific processing program 56 on RAM 30. The specific processing is realized by processor 28 operating as specific processing unit 290 according to the specific processing program 56 executed on RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

In the smart glasses 214, the processor 46 performs the reception output processing. The reception output program 60 is stored in the storage 50. The processor 46 reads the reception output program 60 from the storage 50 and executes the read reception output program 60 on the RAM 48. The reception output processing is realized by the processor 46 operating as the control unit 46A according to the reception output program 60 executed on the RAM 48. Note that the smart glasses 214 may also have a data generation model 58 and an emotion identification model 59, and can perform processing similar to that of the identification processing unit 290 using these models.

Next, the identification processing performed by the identification processing unit 290 of the data processing device 12 is described. The components of the system described below are implemented by the data processing device 12 and the smart glasses 214. In the following description, the data processing device 12 is referred to as the "server," and the smart glasses 214 are referred to as the "terminal."

### Example 1

The flow of the specific processing in Example 1 described in the first embodiment is the same as described above, so the explanation is omitted.

### Application Example 1

The flow of the specific processing in Example 1 described in the first embodiment is the same as above, so the description is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit may acquire step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using the generation AI. For example, the provision unit is implemented by the output device 40 of the smart device 14 or the specific processing unit 290 of the data processing device 12 and provides the generated cooking menu to the user. The correspondence between each unit and the device or control unit is not limited to the examples described above and can be modified in various ways.

The above embodiment described a form where specific processing is performed by the data processing device 12, but the technology disclosed herein is not limited thereto; specific processing may also be performed by the smart glasses 214.

### Third Embodiment

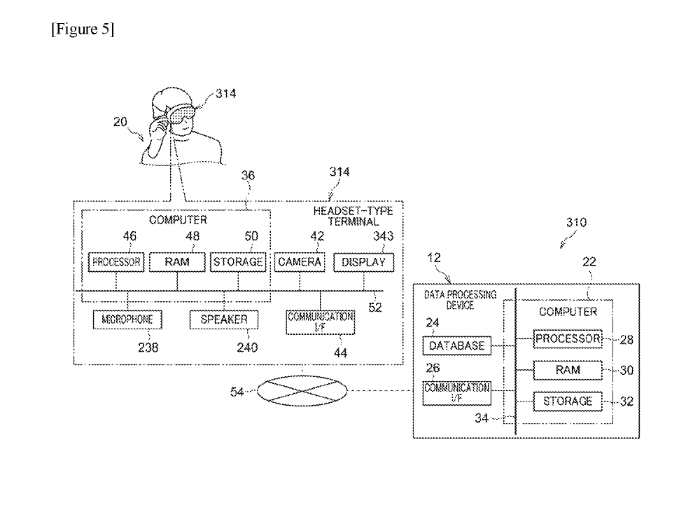

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

Data processing device 12 includes a computer 22, a database 24, and a communication I/F 26. Computer 22 is an example of a "computer" related to the technology of this disclosure. Computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is include a WAN (Wide Area Network) and/or a LAN (Local Area Network).

The headset terminal 314 comprises a computer 36, a microphone 238, a speaker 240, a camera 42, a communication interface 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

Microphone 238 receives voice input from user 20 to accept instructions or other commands. Microphone 238 captures the voice input from user 20, converts the captured voice into audio data, and outputs it to processor 46. Speaker 240 outputs audio according to instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

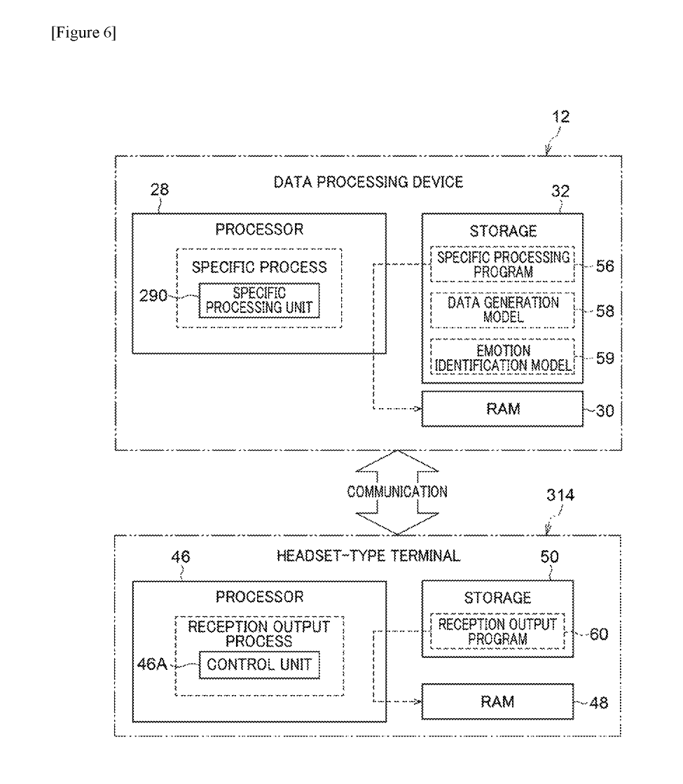

FIG. 6 shows an example of the main functions of the data processing device 12 and the headset-type terminal 314. As shown in FIG. 6, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by specific processing unit 290.

In the headset-type terminal 314, reception output processing is performed by the processor 46. The reception output program 60 is stored in the storage 50. Processor 46 reads the reception output program 60 from storage 50 and executes the read reception output program 60 on RAM 48. Reception output processing is achieved by processor 46 operating as control unit 46A according to the reception output program 60 executed on RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the "server," and the headset-type terminal 314 is referred to as the "terminal."

### Example 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is a so-called generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input prompts containing instructions, as well as inference data such as audio data representing sound, text data representing text, and image data (e.g., still image data or video data) representing images. Data generation model 58 infers based on the input inference data according to the instructions indicated by the prompt and outputs the inference result in one or more of the data formats such as audio data, text data, and image data. The data generation model 58 may include, for example, text generation AI, image generation AI, multimodal generation AI, etc. Here, inference refers to, for example, analysis, classification, prediction, and/or summarization. The specific processing unit 290 performs the specific processing described above using the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14 .Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12. However, the technology disclosed herein is not limited to this, and specific processing may also be performed by the headset-type terminal 314.

### Fourth Embodiment

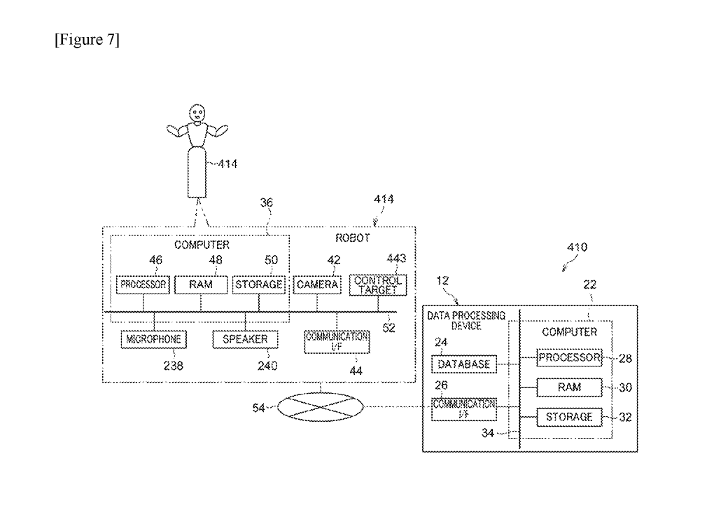

FIG. 7 shows an example configuration of the data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 is an example of a "computer" related to the technology of this disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

Robot 414 includes a computer 36, a microphone 238, a speaker 240, a camera 42, a communication I/F 44, and a control target 443. Computer 36 includes a processor 46, RAM 48, and storage 50. Processor 46, RAM 48, and storage 50 are connected to bus 52. Furthermore, microphone 238, speaker 240, camera 42, and controlled object 443 are also connected to bus 52.

Microphone 238 receives voice commands from user 20 by capturing the user's spoken voice. Microphone 238 captures the voice emitted by user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

The control target 443 includes a display device, LEDs for the eye section, and motors for driving the arms, hands, legs, etc. The posture and gestures of robot 414 are controlled by controlling the motors for the arms, hands, legs, etc. Part of the robot 414's emotions can be expressed by controlling these motors. Furthermore, the robot 414's facial expressions can also be expressed by controlling the light emission state of the LEDs in its eyes.

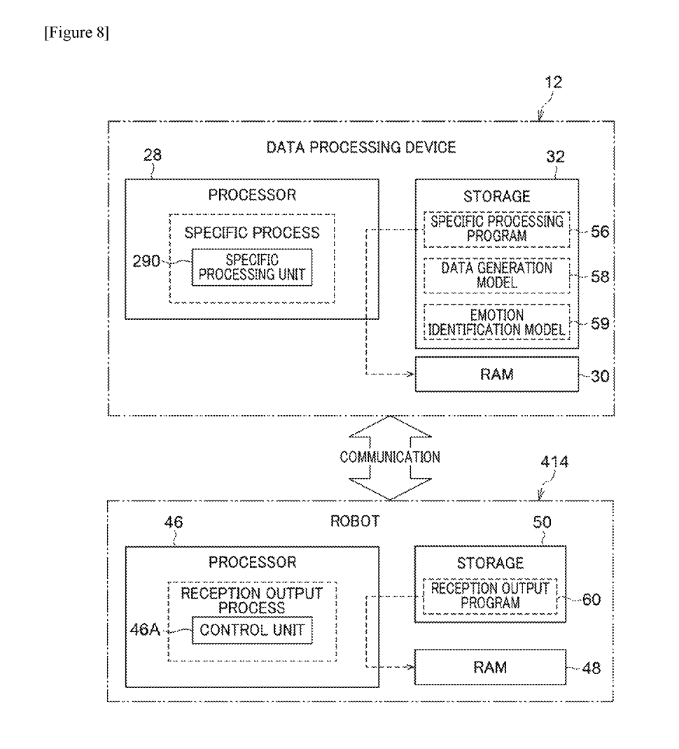

FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In robot 414, reception output processing is performed by processor 46. Storage 50 stores a reception output program 60. Processor 46 reads the reception output program 60 from storage 50 and executes the read reception output program 60 on RAM 48. Reception output processing is realized by the processor 46 operating as a control unit 46A according to the reception output program 60 executed on RAM 48.

Next, the specific processing performed by the specific processing unit 290 of the data processing device 12 is described. The various parts of the system described below are realized by the data processing device 12 and the robot 414. In the following description, the data processing device 12 is referred to as the "server," and the robot 414 is referred to as the "terminal."

### Example 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the robot 414. In the robot 414, the control unit 46A causes the speaker 240 and the control target 443 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like include multiple types of data generation models 58, and the data generation model 58 includes AI other than generative AI. AI other than generative AI includes, for example, linear regression, logistic regression, decision trees, random forests, support vector machines (SVM), k-means clustering, convolutional neural networks (CNNs), recurrent neural networks (RNN), generative adversarial networks (GAN), or naive Bayes, among others. The AI may perform various processing operations, but is not limited to such examples. AI may also be an AI agent. Furthermore, when processing by the aforementioned components is performed by AI, such processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the robot 414.

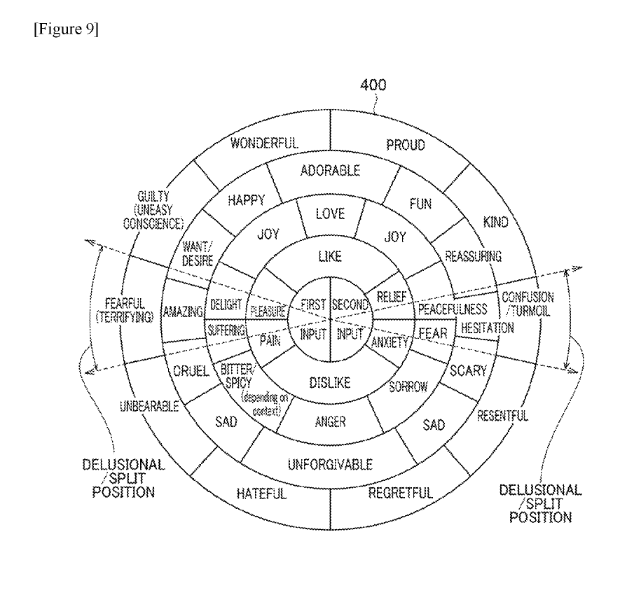

The emotion identification model 59, functioning as an emotion engine, may determine the user's emotion according to a specific mapping. Specifically, the emotion identification model 59 may determine the user's emotion according to an emotion map (see FIG. 9), which is a specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged radially in concentric circles from the center. Emotions closer to the center of the concentric circles represent more primitive states. Emotions representing states or behaviors arising from mental states are placed further out in the concentric circles. Emotion is a concept encompassing affect and mental states. Generally, emotions generated from reactions occurring within the brain are placed on the left side of the concentric circles. Generally, emotions induced by situational judgment are placed on the right side of the concentric circles. Generally, emotions generated from reactions occurring within the brain and also induced by situational judgment are placed in the upper and lower directions of the concentric circles. Furthermore, the upper part of the concentric circle contains "pleasant" emotions, while the lower part contains "unpleasant" emotions. Thus, the Emotion Map 400 maps multiple emotions based on the structure of their origin, with emotions that tend to occur simultaneously mapped close together.

These emotions are distributed around the 3 o'clock position on Emotion Map 400, typically oscillating between feelings of security and anxiety. In the right half of Emotion Map 400, situational awareness takes precedence over internal sensations, resulting in a calmer impression.

The inner part of the emotion map 400 represents the mind, while the outer part represents behavior. Therefore, the further out on the emotion map 400, the more visible the emotion becomes (manifesting in behavior).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. The emotion map is, for example, Dr. Mitsuyoshi's Emotion Map (Based on research on speech emotion recognition and brain physiological signal analysis systems for emotions, Tokushima University, Doctoral Dissertation: https://ci.nii.ac.jp/naid/500000375379). The left half of the emotion map displays emotions belonging to the "Reaction" domain, where sensory aspects predominate. The right half of the emotion map displays emotions belonging to the "Situation" domain, where situational awareness is dominant.

The emotion map defines two emotions that promote learning. One is the negative emotion around the center of the "repentance" or "reflection" area on the situation side. That is, when the robot experiences negative emotions like "I never want to feel this way again" or "I don't want to be scolded anymore. "The other is the positive emotion around "desire" on the reaction side. That is, when the robot feels positive emotions like "I want more" or "I want to know more."

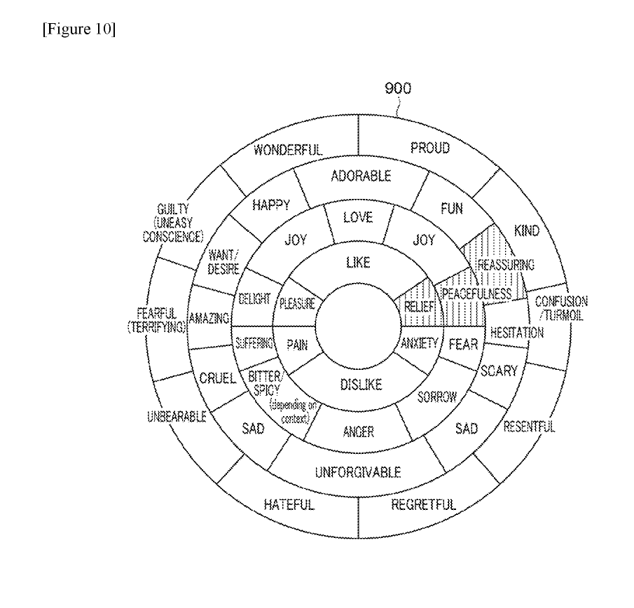

The emotion identification model 59 inputs the user input into a pre-trained neural network, obtains emotion values corresponding to each emotion shown in the emotion map 400, and determines the user's emotion. This neural network is pre-trained based on multiple training data sets, which are combinations of user input and emotion values corresponding to each emotion shown in the emotion map 400. Furthermore, this neural network is trained such that emotions positioned close to each other, as shown in the emotion map 900 in FIG. 10, have similar values. FIG. 10 illustrates an example where multiple emotions, such as "reassurance," "tranquility," and "encouragement," have similar emotion values.

The above description primarily explains the system according to the present disclosure in terms of the functions of the data processing device 12. However, the system according to the present disclosure is not necessarily implemented on a server. The system according to the present disclosure may be implemented as a general information processing system. For example, the present disclosure may be implemented as a software program operating on a personal computer or as an application operating on a smartphone, etc. The method according to the present disclosure may be provided to users in a SaaS (Software as a Service) format.

The above embodiment illustrated an example where specific processing is performed by a single computer 22. However, the technology of this disclosure is not limited thereto. Distributed processing may be performed by multiple computers, including computer 22, for specific processing. For example, data generation model 58 may be provided on an external device of data processing device 12, and said external device may generate data corresponding to input data.

The above embodiment described a configuration where the specific processing program 56 is stored in the storage 32. However, the technology disclosed herein is not limited to this. For example, the specific processing program 56 may be stored on a portable, computer-readable non-volatile storage medium, such as a USB (Universal Serial Bus) memory. The specific processing program 56 stored on the non-volatile storage medium is installed on the computer 22 of the data processing device 12. The processor 28 executes specific processing according to the specific processing program 56.

Alternatively, the specific processing program 56 may be stored on a storage device, such as a server, connected to the data processing device 12 via the network 54. Upon request from the data processing device 12, the specific processing program 56 may be downloaded and installed on the computer 22.

It should be noted that it is not necessary to store the entire specific processing program 56 in a storage device such as a server connected to the data processing device 12 via the network 54, or to store the entire specific processing program 56 in the storage 32. It is also possible to store only a portion of the specific processing program 56.

Various types of processors can be used as hardware resources to execute the specific processing. Examples of processors include a CPU, which is a general-purpose processor that functions as a hardware resource for executing specific processing by executing software, i.e., a program. Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing. Each processor incorporates or connects to memory, and each processor executes specific processing by using this memory.

The hardware resources for executing specific processing may be comprised of one of these various processors, or may be comprised of a combination of two or more processors of the same or different types (e.g., a combination of multiple FPGAs, or a combination of a CPU and an FPGA). Furthermore, the hardware resources for executing specific processing may be a single processor.

Examples of configurations using a single processor include: First, a configuration where one processor is formed by combining one or more CPUs with software, with this processor functioning as the hardware resource executing specific processing. Second, there is a form using a processor that implements the entire system functionality, including multiple hardware resources executing specific processing, on a single IC chip, as exemplified by a System-on-a-chip (SoC). Thus, specific processing is implemented using one or more of the above various processors as hardware resources.

Furthermore, regarding the hardware structure of these various processors, more specifically, electrical circuits combining circuit elements such as semiconductor devices can be used. Also, the specific processing described above is merely one example. Therefore, it goes without saying that within the scope not deviating from the main purpose, unnecessary steps may be omitted, new steps may be added, or the processing order may be changed.

The above description and illustrations provide a detailed explanation of the aspects pertaining to the technology of this disclosure and represent merely one example of the technology disclosed herein. For example, the explanations regarding the configuration, functions, operations, and effects described above are examples of the configuration, functions, operations, and effects pertaining to the aspects of the technology disclosed herein. Therefore, it goes without saying that within the scope of not deviating from the essence of the technology of this disclosure, unnecessary portions may be deleted, new elements may be added, or replacements may be made to the above-described content and illustrated content. Furthermore, to avoid complexity and facilitate understanding of the part pertaining to the technology of this disclosure, descriptions of technical common knowledge, etc., that are particularly unnecessary for enabling the implementation of the technology of this disclosure have been omitted from the above-described content and illustrated content.

All literature, patent applications, and technical specifications cited herein are incorporated by reference to the same extent as if each individual literature, patent application, and technical specification were specifically and individually cited herein.

Regarding the above embodiments, the following is further disclosed.

### Supplementary note 1

A system comprising a sensor unit, a conversion unit, a generative AI unit, and a control unit. The sensor unit is worn on the user's head, comprises multiple electrodes, and has the capability to capture brain electrical activity with high precision. The conversion unit converts analog signals from the sensor unit into digital signals, using an analog-to-digital converter with a high sampling rate to accurately capture subtle changes in brainwaves. The generative AI unit uses deep learning and neural networks to learn patterns in the brainwave signals and estimate the user's intent. The control unit converts the estimated intent into operation commands and controls the actions of the care robot.

### Supplementary note 2

The sensor unit is characterized by having a filtering function to reduce noise, enabling it to minimize interference from the external environment, as described in Supplementary note 1. The sensor unit is constructed from flexible materials to provide a lightweight and comfortable fit, designed to avoid burdening the user even during prolonged use. Furthermore, it can simultaneously acquire brainwaves across different frequency bands, enabling accurate reflection of the user's diverse mental states.

### Supplementary note 3

The system according to Supplementary note 1, wherein the generative AI unit processes large amounts of brainwave data in the cloud to generate customized models for each user. The AI unit implements algorithms to receive new brainwave data as input in real time and to estimate intent quickly and accurately. Furthermore, it can analyze the user's operation history and form a feedback loop to improve the accuracy of operations.

### Explanation of Symbols

10, 210, 310, 410 Data Processing System

12 Data Processing Device

14 Smart Device

214 Smart Glasses

314 Headset-type Terminal

414 Robot

What is claimed is:

1. A system comprising:
a head-worn sensor unit including a plurality of electrodes positioned to contact a scalp of a user and configured to simultaneously acquire brainwave signals in a plurality of frequency bands including alpha, beta, gamma, delta, and theta bands;
a signal conversion unit including an analog-to-digital converter configured to convert the brainwave signals into digital brainwave data at a sampling rate sufficient to capture transient neural activity, the signal conversion unit further configured to apply noise suppression processing that removes at least electromagnetic interference and motion-induced artifacts;
a generative artificial intelligence unit comprising at least one neural network configured to:
receive the digital brainwave data as time-series input,
extract multi-band temporal features from the digital brainwave data, and
estimate a user intent by correlating the extracted features with stored mappings between brainwave patterns and device operations generated from prior brainwave data and execution results; and
a control unit communicatively coupled to the generative artificial intelligence unit and configured to convert the estimated user intent into one or more executable control commands and to operate at least one electronic device in response to the control commands.

2. The system of claim 1, wherein the plurality of electrodes are configured to acquire brainwave signals including alpha, beta, gamma, delta, and theta frequency bands.

3. The system of claim 1, wherein the signal conversion unit includes an analog-to-digital converter operating at a sampling rate of at least several thousand samples per second.

4. The system of claim 1, wherein the signal conversion unit applies filtering to remove electromagnetic noise and motion-induced artifacts from the brainwave signals.

5. The system of claim 1, wherein the generative artificial intelligence unit is trained using brainwave data and corresponding user operation histories to establish mappings between brainwave patterns and device operations.

6. The system of claim 1, wherein the control unit executes the operation on at least one of a smartphone, a wearable device, smart glasses, or a robot.

7. A system for estimating user intent from brainwave signals, comprising:
an input interface configured to receive digital brainwave data derived from brainwave signals acquired by a wearable brainwave sensor, the digital brainwave data comprising time-synchronized signals from a plurality of frequency bands;
a generative AI processing unit comprising a neural network architecture trained to process sequential brainwave data, the generative AI processing unit being configured to:
model temporal relationships among the frequency bands over a sliding time window,
generate an intent hypothesis corresponding to a candidate device operation, and
update internal model parameters based on execution feedback indicating whether a previously generated intent hypothesis resulted in a successful device operation; and
an output interface configured to transmit the intent hypothesis to a device control module that executes the candidate device operation.

8. The system of claim 7, wherein the generative AI processing unit employs deep learning to model temporal changes in the brainwave data.

9. The system of claim 7, wherein the generative AI processing unit generates a user-specific intent model based on historical brainwave data of an individual user.

10. The system of claim 7, wherein the generative AI processing unit updates parameters of the neural network using feedback derived from success or failure of executed device operations.

11. The system of claim 7, wherein the estimated user intent corresponds to a command selected from application execution, message transmission, media control, or device configuration.

12. The system of claim 7, wherein the input interface receives the digital brainwave data in real time and the output interface transmits the estimated user intent with latency below a predetermined threshold.

13. A system for operating an electronic device based on brainwave signals of a user, comprising:
a wearable brainwave acquisition device configured to detect electrical brain activity of the user and to transmit corresponding brainwave data wirelessly;
a processing system including at least one processor and memory storing instructions that, when executed, cause the processing system to:
digitize the brainwave data,
perform signal normalization and feature extraction across multiple frequency bands,
apply a trained generative artificial intelligence model to the extracted features to estimate a user intent corresponding to a device operation, and
refine the generative artificial intelligence model using stored associations between prior estimated intents and resulting device behaviors; and
a device control system configured to translate the estimated user intent into executable control commands and to operate the electronic device according to the control commands.

14. The system of claim 13, wherein the wearable brainwave acquisition device includes wireless communication circuitry for transmitting the detected brain activity to the processing system.

15. The system of claim 13, wherein the processing system executes the generative artificial intelligence model on a remote server in communication with the wearable brainwave acquisition device.

16. The system of claim 13, wherein the device control system is configured to execute multiple control commands corresponding to different user intents in a multitasking manner.

17. The system of claim 13, wherein the processing system monitors abnormal brainwave patterns and generates a notification when a deviation from a predefined threshold is detected.

18. The system of claim 13, wherein the system forms a feedback loop by storing executed control commands and corresponding brainwave data to improve future intent estimation accuracy.
